(19) United States
(12) Patent Application Publication
(10) Pub. No.: US 2007/0171675 A1
(43) Pub. Date: Jul. 26, 2007

(54) Back light and liquid crystal display employing it

(75) Inventors: Toyohiro Sakai, Tottori (JP); Toshiya Nishio, Tottori (JP)

Correspondence Address: SoCAL IP LAW GROUP LLP, 310 N. WESTLAKE BLVD. STE 120, WESTLAKE VILLAGE, CA, 91362, US

(73) Assignees: Sanyo Electric Co., Ltd., Moriguchi-shi, Osaka (JP); Tottori Sanyo Electric Co., Ltd., Tottori (JP)

(21) Appl. No.: 10/598,498

(22) PCT Filed: Feb. 24, 2005
(86) PCT No.: PCT/JP05/02983

§ 371 Date: Aug. 31, 2006

(30) Foreign Application Priority Data
Mar. 1, 2004 (JP) 2004-055875
Mar. 19, 2004 (JP) 2004-079545

(51) Int. Cl. F21V 7/04

(52) U.S. Cl. 362/613; 362/614; 362/609

(57) ABSTRACT

When viewed from the end face side of a light guide plate, all linear lamps in a backlight may be arranged to be able to be viewed directly without being intercepted by other lamps and supported by a spacer. A lamp reflector may have a back surface facing the plurality of linear lamps, and a side face for supporting the back surface against the light guide plate, wherein the back surface may have a reflective surface projecting inward at the central part along the longitudinal direction of the reflector. Luminance of the light guide plate may be enhanced by utilizing lights exiting the linear lamps efficiently in the backlight of a large liquid crystal display, appropriate intervals may be sustained among the plurality of linear lamps, and luminance lowering due to high frequency interference caused by a contact of each linear lamp with a reflector may be prevented.

### TECHNICAL FIELD

The present invention relates to a backlight in a liquid crystal display, and especially relates to an assembly fixing structure of a linear lamp in an edge-lit backlight which uses a linear-shaped lamp as a backlight light source, and a liquid crystal display which employs such backlight.

### RELATED ART

Liquid crystal displays, which are power-saving, thin and light-weight, are being promoted as display devices for large televisions or similar devices. There is, therefore, a need for a backlight to be used in such devices which has stable luminance and high reliability.

Examples of this kind of liquid crystal display include a system which irradiates light from a backlight arranged on a back surface of a liquid crystal panel onto the liquid crystal panel so that the images formed on the liquid crystal panel can be viewed, a direct-lighting system and a side-lighting system. The direct-lighting system is often employed in backlights which require high luminance, such as large liquid crystal modules or mid-size televisions. However, with a direct-lighting system, the thickness increases, meaning that such a system is unsuitable for thin-type modules. Further, a direct-lighting system requires a large number of light sources, which increases the cost. Thus, in mid-size laptop computers or monitors, which need to be thin but do not require high luminance, a side-lighting system is usually employed. In a side-lighting system backlight a light guide source. A reflector is arranged on the back surface of the light guide plate, and a diffuser is arranged on the front surface. In the past, a linear cold cathode ray tube has often been used as the light source. Since such a light source is provided on the edge of the light guide plate, it is sometimes called an edge-lit backlight.

In the backlight unit for an edge-lit backlight, the side edge (side end face), which is the light-incident face of the light guide plate made from an acrylic resin or the like, is arranged parallel to the linear lamp outgoing light face. However, in response to the increasing size of liquid crystal televisions or other such liquid crystal displays, there is a trend for the number of long linear lamps being used to increase due to the demands of insufficient luminance and uniformity in the amount of light. Previously, this kind of backlight comprised along the entire length of the linear lamp a roughly U-shaped or semicircular lamp reflector whose side facing the light guide plate of the linear lamp arranged along the side end face of the light guide plate was open. This increased reflection efficiency, and guided the outgoing light from the linear lamp to the light guide plate to illuminate the liquid crystal panel.

The light guide plate is, for example, made from acrylic resin. A white reflector is arranged on the back surface of the light guide plate, and a diffuser is arranged on the front surface. The backlight is arranged on the two side end faces facing the light guide plate, and one or two linear lamps are provided on each side. An example of such a backlight is disclosed in the below Patent Document 1, which will be explained using FIG. 8. This backlight 60 comprises a linear lamp 61 arranged along a side end face which is the light-incident face of a light guide plate (not shown) having a transparent plate which is arranged on the back surface of a liquid crystal panel, a lamp reflector 62 which houses the linear lamp 61 and which has an open aperture on a side end face of the light guide plate, and an insulating spacer 63 which is inserted in between an inner wall of the lamp reflector 62 and an outer wall of the linear lamp 61 for holding and supporting the linear lamp 6 at a fixed interval from the inner wall of the lamp reflector 62.

The lamp reflector 62 has a plurality of spacer latching holes 64 which face each other at a plurality of positions except for the side end face of the light guide plate of the linear lamp 61. The insulating spacer 63 is provided with an interval-regulating protruding part 631 which abuts onto the outer wall of the linear lamp 61, and a fitting part 632 which fits into a spacer latching hole 64 formed on the lamp reflector 62, whereby the linear lamps are held at a fixed interval from the inner wall of the lamp reflector. According to such a configuration, the linear lamps are held not with an O-ring, but with an insulating spacer arranged on the lamp reflector, which confers the advantages that the operation for housing a linear lamp into a lamp reflector can be streamlined, and that the linear lamp can be positioned accurately with respect to the lamp reflector.

In the case of using a pair of two lamps provided along the side end face of the light guide plate, both the end portions of the lamps are supported by a rubber cap to keep the lamps parallel. However, the tube diameter of the lamps is small, so that for a large liquid crystal display whose length is increased, warping or bending in the lamps may occur due to variances in production or heat generation during operation, whereby the center portion of the lamp may come into contact with the reflective cover, which causes current leakage at the contacting portion, whereby luminance may drop.

To resolve these problems, the backlight unit disclosed in the below Patent Document 2, as illustrated in the essential element plan diagram of FIG. 9A, comprises two direct tube fluorescent lamps 75, 76 which are provided parallel to the side end face of a rectangular, flat light guide plate 71 at an angle to each other and which light up at a high frequency of 15 KHz or more, and a reflective cover 78 which surrounds the outer side of each of the straight tube fluorescent lamps which reflects the light from the high-frequency lit fluorescent lamps for focusing onto the side end face of the light guide plate. An insulating spacer 79 for preventing the fluorescent lamps and the reflective cover 78 from coming into contact due to warping or the like of the fluorescent lamps 75, 76, is mounted in places on about the center portion of the two direct tube fluorescent lamps 75, 76 which are provided on an end face of the light guide plate. This insulating spacer 79 can be, as denoted by numerals 791 and 792 of FIGS. 9B and 9C, a short transparent ring or elastic ring such as a silicon pipe, and also comprises the function of maintaining the interval with the fluorescent lamps 75, 76 in a fixed manner. By preventing the reflective cover and the fluorescent lamps from coming into contact, a drop in the luminance of the fluorescent lamps which are lit at a high-frequency is prevented.
[Patent Document 1] J P-A-2002-203419
[Patent Document 2] JP-A-07-272513

### DISCLOSURE OF THE INVENTION

### Problems to be Solved by the Invention

The configuration of the backlight 60 disclosed in the above Patent Document 1 uses a spacer pre-arranged on the lamp reflector, rather than inserting an O-ring, to hold a linear lamp, thereby enabling the operation for housing the linear lamp into a lamp reflector to be streamlined, and the linear lamp to be positioned accurately with respect to the lamp reflector. Therefore, a spacer latching hole 64 needs to be formed on the lamp reflector 62. Further, since an interval-regulating protruding part 631 which abuts onto the outer wall of the linear lamp 61 and a fitting part 632 which fits into a spacer latching hole 64 formed on the lamp reflector 62 need to be arranged on the spacer 63, and, attached into the lamp reflector, the contact surface area between the spacer 63 linear lamp 61 and the lamp reflector 62 is large. Problems thus arise that light absorption from the spacer increases, and the components become expensive.

Further, the backlight unit disclosed in the above Patent Document 2 mounts an insulating spacer 79, which prevents the fluorescent lamps 75, 76 and the reflective cover 78 from coming into contact due to warping or the like of the fluorescent lamps, in places about in the center portion of the two direct tube fluorescent lamps 75, 76 which are arranged on an end face of the light guide plate 71. This insulating spacer maintains the interval between the pair of fluorescent lamps or between a fluorescent lamp and the reflective cover, and absorbs impact force. For that reason, the contact surface area with the pair of fluorescent lamps and the reflective cover is large, meaning that light absorption from the spacer is also large. However, Patent Document 2 is silent on how the fluorescent tubes are held when three or more fluorescent lamps are used for a large liquid crystal display.

In addition, for a large liquid crystal display which employs three or more fluorescent lamps on one side, with the angled configuration of the fluorescent lamps as illustrated in FIG. 10 disclosed in the above Patent Document 2, separation between the lamps cannot be achieved and the other lamps become a hindrance, so that the reflection efficiency is poor and luminance is difficult to attain. Accordingly, when employing three or more fluorescent lamps on one side, unresolved problems include how to increase the light utilization efficiency, the provision of a backlight which has overcome how to lessen the disparity in the plurality of wires in a fluorescent lamp which have been led through a back surface and pulled around to both ends, bearing in mind that the back surface of a lamp reflector is flat or curved, and the provision of a spacer whose assembly operation for a plurality of fluorescent lamps is good.

As a result of various investigations to resolve the above problems, the inventors of the present invention arrived at the present invention by focusing on the fixing state and the fixing means of a linear lamp, discovering that the above problems can be resolved by innovatively designing the placement of the linear lamps when three or more linear lamps are placed close but in contraposition to one end face of a light guide plate, and the shape of the insulating spacer for maintaining an interval between a linear lamp and the lamp reflector structure which fixes the linear lamp.

That is, it is an object of the present invention to efficiently utilize the outgoing light of a linear lamp to increase the luminance of a light guide plate, especially for a backlight of a large liquid crystal display which uses a cold cathode as a light source.

It is a further object of the present invention to provide a backlight which is easy to position accurately opposite a linear lamp on a side end face of a light guide plate of a backlight unit, in which the fixing and the wiring of the linear lamp has been made easy during component assembly. It is still another object of the present invention to provide a backlight wherein an insulating spacer properly maintains the intervals among a plurality of linear lamps and prevents a reduction in luminance due to high-frequency interference caused by the respective linear lamps and reflectors coming too close to each other or coming into contact with each other, as well as reduces the light absorption caused by the insulating spacer itself.

In addition, it is another object of the present invention to provide a liquid crystal display which uses a backlight comprising the above-described characteristics.

### MEANS TO SOLVE THE PROBLEMS

To resolve the above-described problems, the invention in accordance with the backlight of claim 1 according to the present invention is a backlight comprising a light guide plate, three or more linear lamps arranged along an end face of the light guide plate, an insulating spacer provided in an intermediate position in a longitudinal direction of the linear lamps for supporting the linear lamps, and a lamp reflector arranged so as to surround the linear lamps for reflecting light from the linear lamps to a light guide plate side,

the linear lamps being, when viewed from an end face side of the light guide plate, arranged so that all the linear lamps are directly visible without being shielded by another linear lamp, and among the linear lamps, a center linear lamp in a thickness direction of the light guide plate end face being arranged closer to the light guide plate side than other linear lamps,

the insulating spacer comprising a plurality of apertures, and among the plurality of apertures, a center aperture being arranged closer to the light guide plate side than other apertures, and

the lamp reflector comprising a back surface which faces the plurality of linear lamps and the face for supporting the back surface against the light guide plate, the back surface having a convex portion projecting inward at a center portion along a longitudinal direction of the reflector.

Further, the invention set forth in claim 2 is such that, in the backlight according to claim 1, the plurality of linear lamps is an uneven number.

Further, the invention set forth in claim 3 is such that, in the backlight according to claim 1, a slit is formed along a longitudinal direction on the lamp reflector back surface, and in that cables connected to the linear lamps are housed in the slit.

Further, the invention set forth in claim 4 is such that, in the backlight according to claim 1, at least one of the plural apertures is a through hole, and other apertures comprise a dividing slit which extends from a periphery to the aperture.

Further, the invention set forth in claim 5 is such that, in the backlight according to claim 4, the insulating spacer is made from transparent silicon rubber.

Further, the invention set forth in claim 6 is such that, in the backlight according to claim 1, the insulating spacer is provided with a taper whose contact surface area of at least one contact section with the linear lamps, lamp reflector, or light guide plate is made to decrease, and whose transverse cross-section shape is formed in a tapered manner.

Further, the invention set forth in claim 7 is such that, in the backlight according to claim 6, the taper of the insulating spacer is formed from a plurality of planes.

Further, the invention set forth in claim 8 is such that, in the backlight according to claim 6, the insulating spacer is formed from transparent silicon rubber.

Further, the invention of a liquid crystal display set forth in claim 9 is such that the backlight according to any of claims 1 to 8 is arranged on a back surface of a liquid crystal panel.

### EFFECTS OF THE INVENTION

According to the present invention, the distribution of incident light from a linear lamp to a light guide plate of a backlight unit is uniform and can therefore be efficiently utilized, whereby a high-quality backlight having a high luminance can be attained. Therefore, especially if used in a large liquid crystal display which employs a plurality of linear lamps as a backlight, a bright and high-quality liquid crystal display can be attained.

### BRIEF DESCRIPTION OF THE DRAWINGS

FIG. 1 is an exploded perspective view illustrating the backlight structure of a backlight unit according to the present invention.

FIG. 2 is a structural cross-sectional view of the backlight of FIG. 1.

FIG. 3 is a structural cross-sectional view of a FIG. 2 related-art backlight.

FIG. 4 is a plan view of a first specific example of an insulating spacer used in the present invention.

FIG. 5 is a plan view of a second specific example of an insulating spacer used in the present invention.

FIG. 6 is a plan view of a third specific example of an insulating spacer used in the present invention.

FIG. 7 is a plan view of a fourth specific example of an insulating spacer used in the present invention.

FIG. 8 is an exploded perspective view illustrating the structure of a backlight in a related-art liquid crystal display.

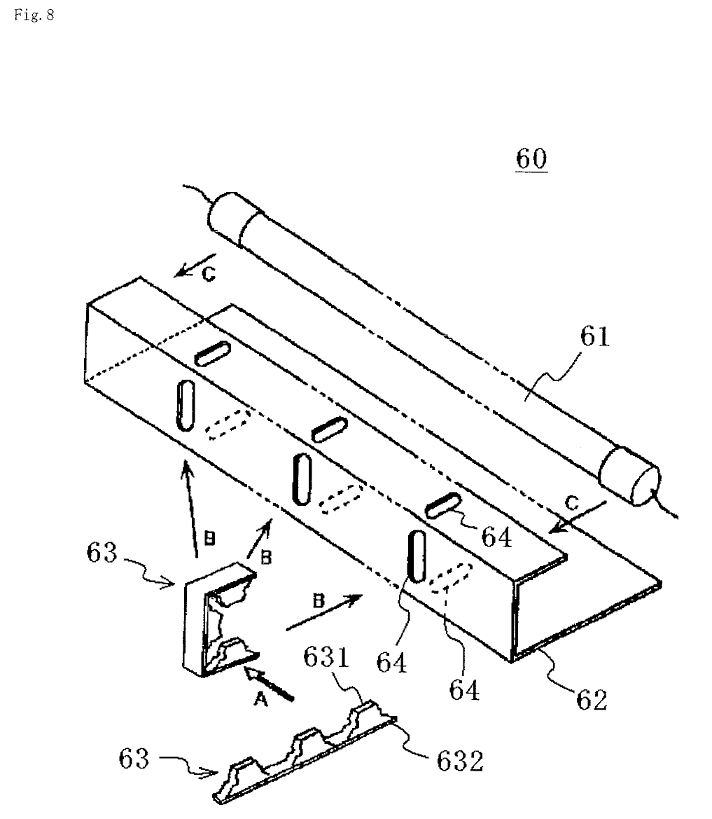

FIG. 9A is a plan view illustrating the essential parts with some parts missing of a related-art backlight unit, and FIGS. 9B and 9C are perspective views explaining a related-art insulating spacer.

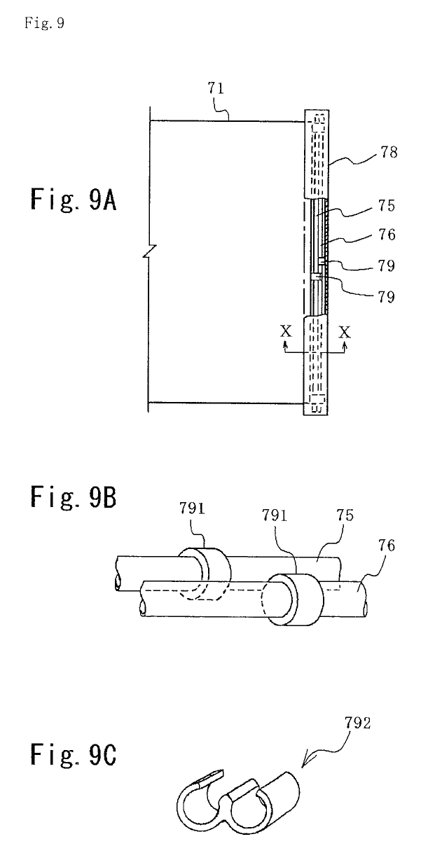

FIG. 10 is an exploded cross-sectional view along the line X-X of FIG. 9A.

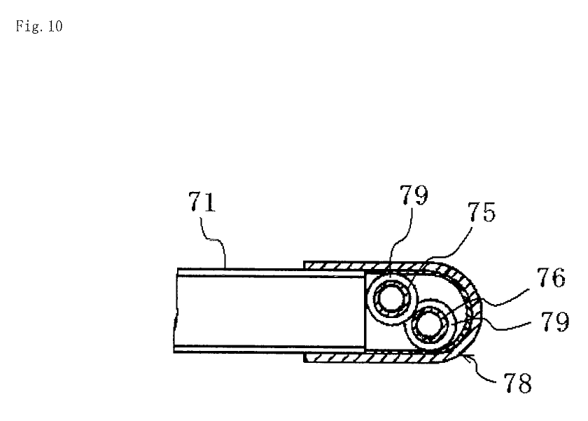

### EXPLANATION OF THE REFERENCE NUMERALS

| | |
|---|---|
| 10 | Backlight |
| 11a, 11b, 11c | Linear lamp |
| 12a, 12b | Cap |
| 13 | Lamp reflector |
| 14, 14A to 14D | Insulating spacer |
| 15a to 15c | Cable |
| 16a, 16b | Connector |
| 17 | Light guide plate |
| 18 | Diffuser |
| 19 | Reflector |
| 131 | Slit |

### EMBODIMENTS OF THE INVENTION

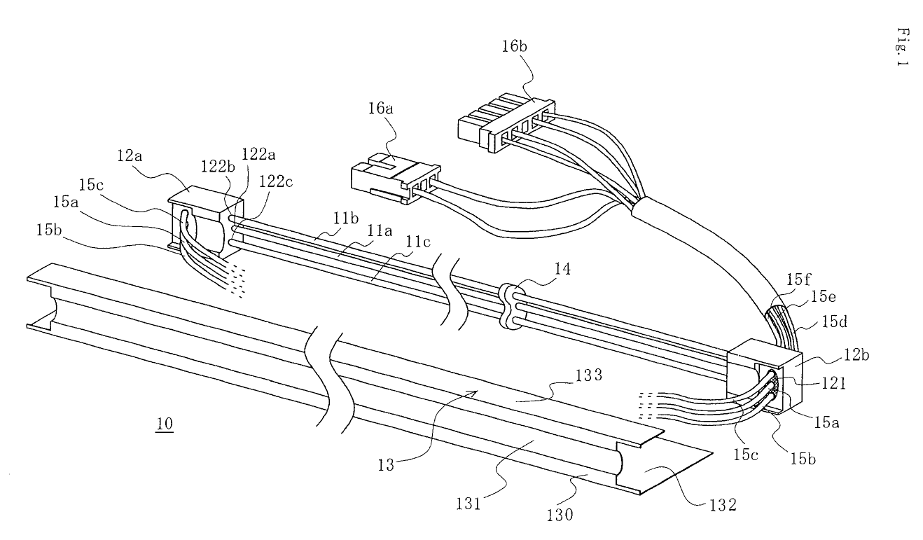

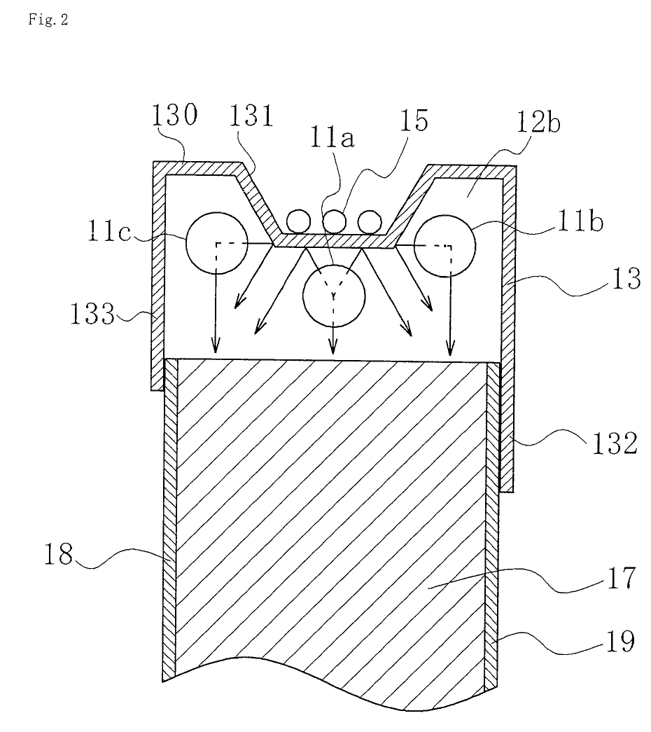

The fixing onto a lamp reflector of a linear lamp in a backlight according to the present invention will now be explained in more detail by referring to a working example and the accompanying drawings. FIG. 1 is an exploded perspective view of a backlight 10 according to the present invention, which is provided on a side end face of a light guide plate in a liquid crystal display such as a large television, and FIG. 2 illustrates a structural cross-sectional view of the backlight 10 of FIG. 1. Since there is a limit to the luminance from one linear lamp, if a liquid crystal display is made larger, the number of backlight linear lamp needs to be increased. However, in FIGS. 1 and 2, an example will be explained in which three linear lamps are used.

### EXAMPLE

Although an illustration of the liquid crystal display backlight unit has been omitted, the backlight unit combines a prism sheet arranged on the back surface of a liquid crystal panel, a diffuser arranged on the front surface of a light guide plate, an acrylic light guide plate that has a rectangular flat shape, and a reflector arranged on the back surface of the light guide plate, wherein linear lamps provided on the lamp reflector on two side end faces facing the light guide plate are installed so as to be parallel to the light guide plate.

The three linear lamps 11a to 11c, which are cold cathode ray tubes, are long, thin and straight tubes that are from 1.8 to 2.0 mm in diameter and from 300 to 460 mm in length. Once cables have been connected to the terminals at both ends of the linear lamps, caps 12a, 12b made from silicon rubber are fitted thereon. The caps 12a, 12b are fixed to both ends of the lamp reflector 13 to attach the linear lamps 11a to 11c to the lamp reflector 13. The linear lamp 11a, which is arranged in the center, is provided with an insulating spacer 14 on a center portion in the longitudinal direction thereof, the linear lamp 11a being inserted through an insulating spacer aperture beforehand. The other two linear lamps 11b, 11c were also inserted through the hole of an insulating spacer 14 when being fitted with the caps 12a, 12b, and the interval therebetween is maintained so as to keep the lamps parallel.

The lamp reflector 13 is formed by molding a metal sheet, e.g. an aluminum sheet, which is about the same length as the linear lamps, into an approximate U-shape across its cross section, and then adhering a reflective sheet, such as an evaporated silver sheet, onto the inner side face thereof. The lamp reflector 13, which is fixed so as to surround the linear lamps, is provided with U-shaped open portions which face each other on a side end face of the light guide plate. The lamp reflector 13 comprises a back surface 130 which faces the plurality of linear lamps and side faces 132, 133 which support the back surface against the light guide plate. The back surface 130 of the lamp reflector has a convex portion, which acts as a reflective surface, projecting inward at a center portion along a longitudinal direction of the reflector. That is, the back surface of the lamp reflector 13 is provided with a continuous indentation which projects into the inner side of the U-shape along a longitudinal direction thereof, to form a slit 131 on the back surface.

Light generated on the back surface side from the linear lamps 11 is reflected by the lamp reflector 13 and guided towards the light guide plate 17. However, if the three linear lamps 11a to 11c are housed within the lamp reflector 13, reflected light from a linear lamp will sometimes be shielded by another linear lamp. In view of this, the lamp reflector 13 according to the present invention has a slit 131. The shape of this slit 131 is designed so that the light from the linear lamps 11a to 11c is efficiently reflected towards the light guide plate 17. In the present example, the three faces constituting the slit 131 are each formed roughly flat, wherein the face facing the center linear lamp 11a is provided roughly parallel to the end face of the light guide plate 17 and the other two faces are provided at an angle to the light guide plate 17 end face. The angled direction of these faces is such that the width of the slit 131 becomes narrower heading towards the light guide plate 17 side. Since the face facing the center linear lamp 11a is formed roughly parallel to the light guide plate 17 end face, light from the linear lamp 11a is reflected by this face, and is guided to the light guide plate 17 without being inhibited by the other linear lamps 11b, 11c. Further, since in the slit 131 the faces positioned adjacent to the linear lamps 11b, 11c are at an angle to the light guide plate 17 side, light from the linear lamps 11b, 11c is efficiently reflected to the light guide plate 17 side by these faces. The plural cables 15a to 15c attached to one end of each of the linear lamps are housed in this slit 131. These plural cables 15a to 15c are pulled through the outer side of the lamp reflector 13 to the other end, passed through an aperture 121 of the cap 12b at the other end of the linear lamp, and connected to the other end of the linear lamp. The cables 15d to 15f, which have been pulled out from the other end, are pulled out together from the cap front surface and distributed, whereby the connectors 16a, 16b are connected at a tip portion. The plural cables 15a to 15c do not have to be passed through the center of the slit 131, and may also be fixed to the slit with an adhesive or the like.

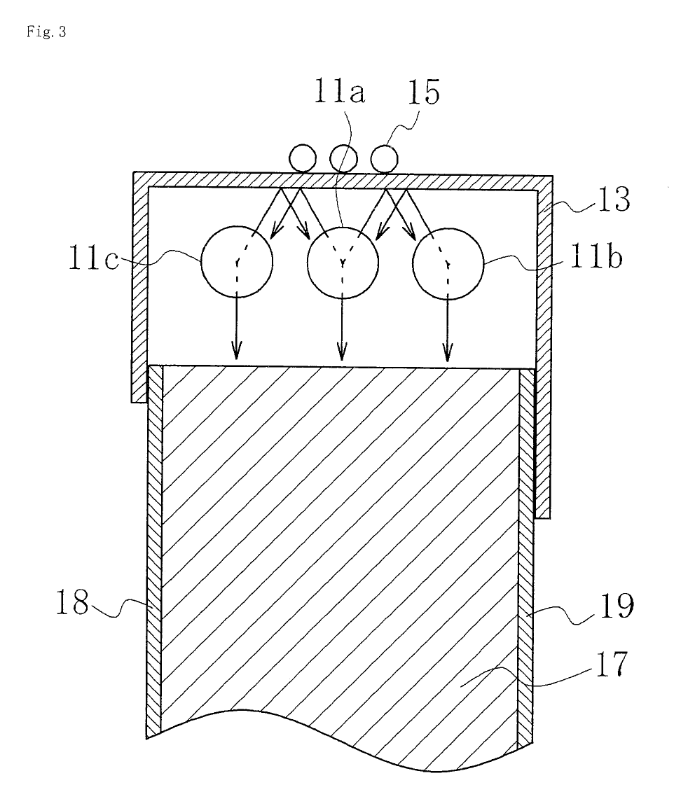

The backlight section 10 will now be explained. Caps 12a, 12b, which are made from a silicon resin and which are fitted into the lamp reflector 13, are configured so that the positioning of the apertures which are to be provided for the linear lamps 11a to 11c is such that a center support aperture 122a is provided closer to the light guide plate 17 side and the support apertures 122b, 122c on either side thereof are provided further back. Thus, as illustrated in FIG. 2, of the three linear lamps provided in the lamp reflector 13, the center linear lamp 11a is arranged closer to the light guide plate 17 side than the other linear lamps 11b, 11c, and a slit 131 is formed on the back surface of the lamp reflector 13, wherein the slit wall has a convex portion being formed from the angles into the inner side. This means that the separation between linear lamps is larger and the reflective face of the lamps on either side broader than that for the comparative example illustrated in FIG. 3, wherein the back surface is flat, the lamps are aligned on the same face on an identical-width lamp reflector having. As a result, the outgoing light from each lamp is efficiently irradiated onto the light guide plate 17 without being absorbed by the lamps themselves. Moreover, an indentation adapted to the slit of the lamp reflector 13 is provided on the back surface of the caps 12a, 12b which are fitted onto both ends of the lamp reflector 13. In addition, in FIG. 2 reference numeral 18 denotes a diffuser and reference numeral 19 denotes a reflector. In FIG. 3, structural elements which have the same configuration as those in FIG. 2 are denoted with the same reference numerals.

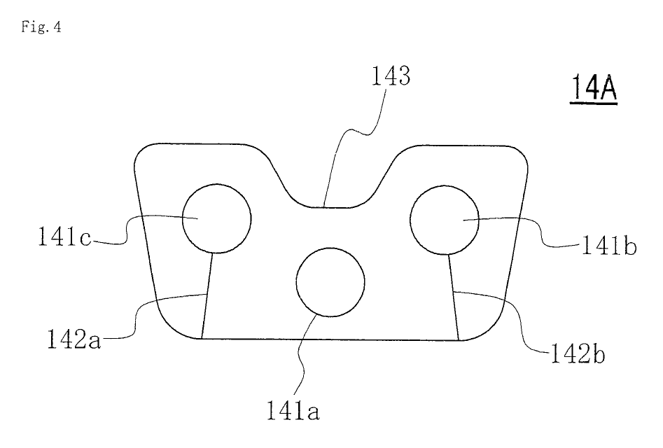

FIG. 4 illustrates a plan view of a first specific example of an insulating spacer 14 used in the present invention. The insulating spacer 14A according to this first specific example is such that an intermediate center portion of each of the linear lamps 11a to 11c in its longitudinal direction is supported by an elastic insulating spacer 14A which has a plurality of apertures 141a to 141c. At least one of the insulating spacer apertures (in this case, the center aperture 141a) is a through-hole. The other apertures 141b, 141c comprise dividing slits 142a, 142b which extend from the periphery to the apertures. This insulating spacer 14A is arranged so that the center portion aperture 141a is closer to the light guide plate than the other apertures 141b, 141c. The insulating spacer 14A is preferably made from a transparent silicon rubber so that the outgoing light from the linear lamps is not inhibited. Providing dividing slits 142a, 142b in the apertures 141b, 141c, allows for simple installation by fitting the insulating spacer 14A after the caps have been attached to the other lamps as long as one linear lamp has already been inserted. Further, the back surface of the insulating spacer 14A is formed with an indentation 143 which is adapted to the slit on the back surface of the lamp reflector 13.

Even if the set of three linear lamps 11a to 11c warp or bend due to heat generation or the like, this insulating spacer 14A can prevent direct contact between the linear lamps and the metal reflective sheet (not shown), since the insulating spacer in the center portion of each linear lamp is in contact with the metal reflective sheet of the lamp reflector. Therefore, the generation of high-frequency leakage current due to a linear lamp coming too close to or directing contacting the metal reflective sheet can be prevented, thereby eliminating the risk of the linear lamp luminance decreasing.

In addition, because the insulating spacer 14A maintains a fixed interval between the lamps at a center portion in the longitudinal direction of the set of three linear lamps, damage caused by collisions among the linear lamps can be prevented. The insulating spacer 14A also acts to prevent damage by protecting the linear lamps against external impact forces. A plurality of insulating spacers may be used with gaps therebetween as necessary based on the length of the linear lamps.

While transparent spacers are preferable as the insulating spacer 14A, since a transparent spacer improves the utilization efficiency of the light from the linear lamps, as long as a spacer is used which has a thickness in its axial direction of no greater than 2 mm, there are no practical adverse effects on luminance of the light guide plate 17.

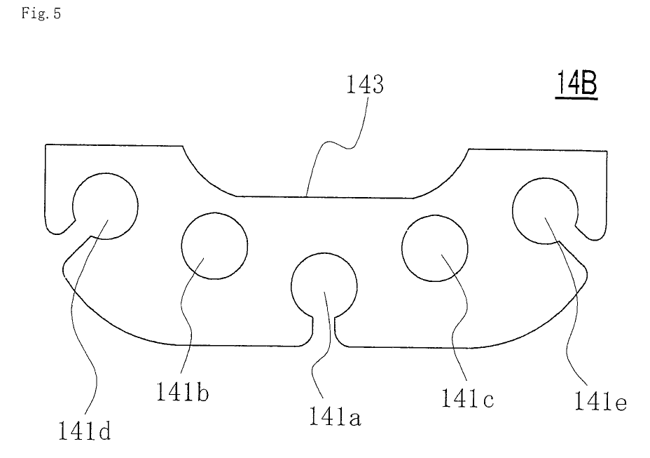

FIG. 5 illustrates a plan view of a second specific example of an insulating spacer 14, wherein structural elements which have the same configuration as those of the insulating spacer 14A in the above-described first specific example are denoted with the same reference numerals. The insulating spacer 14B according to this second specific example is used for the linear lamps in a backlight having five lamps as a set. The support apertures are configured in the following manner. In the center is the aperture 141a, which arranged closest to the light guide plate and whose center is provided with a cut-off slit. Through-holes 141b, 141c, which do not have a cut-off slit, are sandwiched at either end by apertures 141d, 141e, which do have a cut-off slit, so that the apertures are formed in an arc which gradually moves away from the light guide plate. In the center and at either end are provided cut-off slits which extend to the respective aperture. In this configuration two linear lamps are inserted, and the other linear lamps may be fitted in later, which makes mounting easy. Moreover, in this case the arrangement of the cap holes which fit onto either end of the linear lamps is obviously in an arc shape as well.

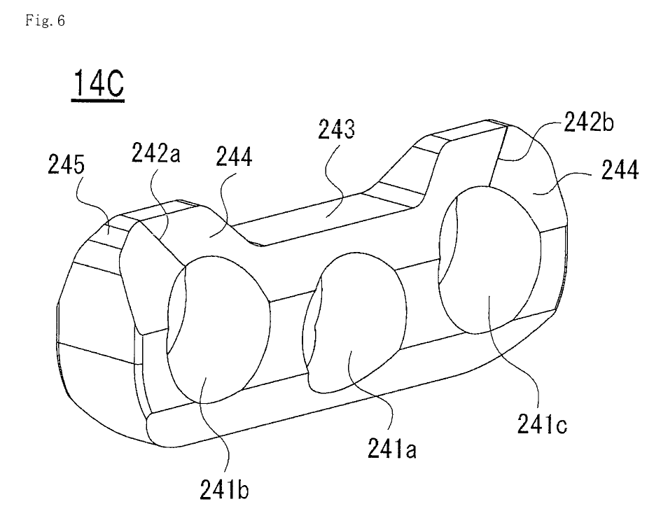

FIG. 6 illustrates a perspective view of the third specific example of an insulating spacer 14. The insulating spacer 14C according to this third specific example has a plurality of apertures 241a to 241c which support an intermediate center portion in a longitudinal direction of each of the linear lamps 11a to 11c. At least one of these apertures 241a to 241c of the insulating spacer 14C, for example the center aperture 241a, is made a through hole, and the other apertures 241b, 241c may be provided as apertures which comprise cut-off slits 242a, 242b which extend from the periphery to the apertures. This insulating spacer 14C is arranged such that the center aperture 241a is closer to the light guide plate than the other apertures 241b, 241c. The insulating spacer 14C is preferably made from a transparent silicon rubber from the viewpoints of heat resistance and so that the outgoing light from the linear lamps 11a to 11c is not inhibited. Providing cut-off slits 242a, 242b in the apertures 241b, 241c allows for simple installation by opening the cut-off slits 242a, 242b and fitting the insulating spacer 14C after the caps 12a, 12b have been attached to the other lamps as long as one of the linear lamps 11a to 11c has already been inserted. Further, the back surface of the insulating spacer 14C is formed with an indentation 243 which is adapted to the slit on the back surface of the lamp reflector 13.

Incidentally, the insulating spacer 14 faces demands in terms of heat resistance, electrical insulating properties, and its degree of transparency, and is thus normally made out of silicon rubber. To stably fix the lengthy linear lamps 11a to 11c and to protect from shocks, the insulating spacer 14 needs to be fixed by being in contact with the lamp reflector 13, the metal reflective sheet or the light guide plate. However, since silicon rubber possesses high thermal conductivity, the larger the surface area in contact with the linear lamps 11a to 11c, the lamp reflector 13, the metal reflective sheet or the light guide plate, and the greater the absorption of light from the lamps, the faster the heat transfer from the linear lamps 11a to 11c (cold cathode ray tubes) to the lamp reflector 13, a lamp reflector 13 comprising a reflective sheet attached thereto, or a light guide plate side. For this reason, the temperature drops in some places in the linear lamps 11a to 11c. This drop in temperature in some places causes silver atoms in the lamps to concentrate at such places, whereby the number of silver atoms present in an entire lamp decreases and uneven luminance occurs, thereby causing the overall luminance to fall. Moreover, the partial concentration of silver atoms blackens the linear lamps 11a to 11c in some places, which is manifested on the display screen of a liquid crystal display as display unevenness that appears black.

Therefore, the insulating spacer 14C according to this third specific example is formed such that its transverse cross-section is tapered by a taper 244, so that the contact surface area among the insulating spacer 14C, the lamp reflector 13, and the light guide plate becomes smaller. Since this insulating spacer 14C is overall formed in a long and thin manner, the contact surface area with the lamp reflector 13 and the light guide plate increases more for the end face along the longitudinal direction of the insulating spacer 14C. For this reason the taper 244 is formed along the longitudinal direction on the insulating spacer 14C. However, in order for the linear lamps 11a to 11c to be supported by the insulating spacer 14C, the contact surface area between the linear lamps 11a to 11c and the insulating spacer 14C cannot be drastically decreased. Therefore, at the portion where the taper 244 is formed, the thickness of the insulating spacer 14C is made gradually thinner going from the edge of the apertures 241a to 241c towards the end portion of the insulating spacer 14C. As illustrated in FIG. 6, the taper 244 may also be formed into diamond cuts by a plurality of faces. In addition, the taper 244 may be provided not only in the transverse cross-section but also as a taper 245 cutting across a corner of the insulating spacer 14C.

If the taper 244 is constituted from diamond cuts, only the portions which need to be removed are cut off, whereby the contact surface area between the linear lamps 11a to 11c and the insulating spacer 14C, the contact surface area between the insulating spacer 14C and the light guide plate, and the contact surface area between the insulating spacer 14C and the lamp reflector 13 can each be formed as small as possible, while not causing any harm to the insulating spacer 14C holding function of the linear lamps 11a to 11c. While in FIG. 6 the taper 244 is formed in a planar shape, the taper 244 can also be formed from a plurality of planes or curved faces, and may even be formed from a thin-wall portion close to the abutting tip.

From the perspective of preventing a drop in temperature of the linear lamps 11a to 11c, the contact surface area between the insulating spacer 14C and the linear lamps 11a to 11c is preferably made as small as possible. Accordingly, it is effective if the taper 244 is formed as far as the edge portion of the apertures. However, to reliably support the linear lamps 11a to 11c, the contact surface area between the insulating spacer 14 and the linear lamps 11a to 11c must be secured to a certain extent, and thus cannot be dramatically reduced. The insulating spacer 14C has a larger contact surface area with the lamp reflector 13 than with the light guide plate, and, in terms of its materials, the lamp reflector 13 tends to transmit heat more easily than the light guide plate. Thus, a larger effect can be attained by especially reducing the contact surface area between the insulating spacer 14C and the lamp reflector 13. While some backlights arrange the insulating spacer 14C and the light guide plate slightly apart, even in that case depending on usage conditions the insulating spacer 14 and the light guide plate may come into contact with each other. For this reason, it is effective to form the taper 244 on the light guide plate side of the insulating spacer 14C, as in the present invention.

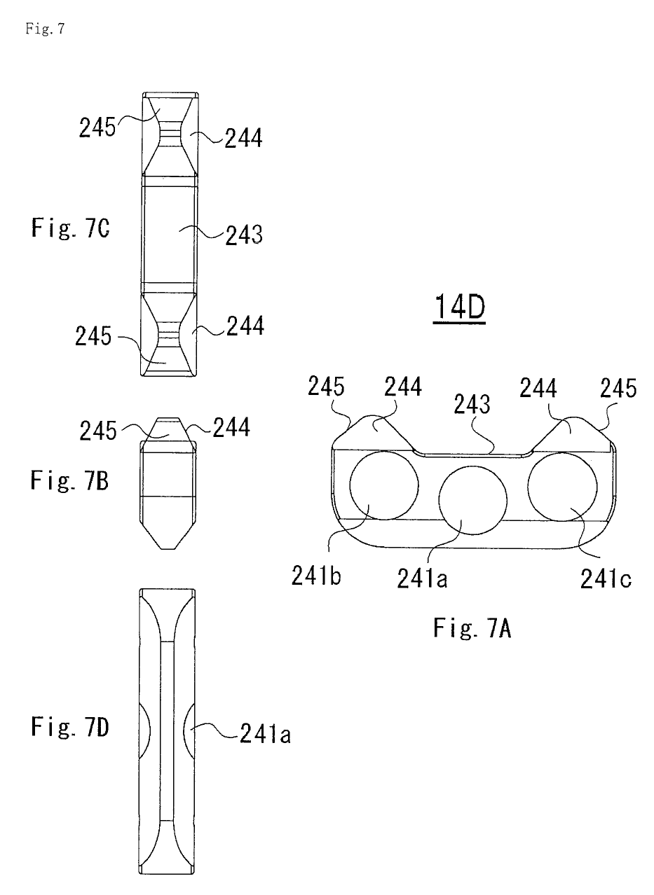

FIG. 7 respectively illustrates a front view (7A), a side view (7B), a top view (7C) and a bottom view (7D) of a fourth specific example of an insulating spacer, wherein structural elements which have the same configuration as those of the insulating spacer 14C in the above-described third specific example are denoted with the same reference numerals. As is clear from the side view FIG. 7B, the insulating spacer 14D according to this fourth specific example may have a tapered transverse cross-section as a whole, and except for the slit portion 243 which has the possibility of being exposed to a strong impacts force, the upper face in contact with the lamp reflector 13 is formed in a tapered manner by the taper 244. The taper 244 is arranged on the end face along a longitudinal direction of the insulating spacer 14D, so that the contact surface area of the contacting portion between the insulating spacer 14D and the lamp reflector 13 and the contact surface area with the light guide plate is reduced.

In the above example the lamp reflector was explained for an object having a U-shaped cross-section. However, the lamp reflector is not limited to having a U-shaped cross-section, and the present invention can be applied in the same manner for objects whose cross-section is semicircular, semi-elliptical, parabolic or the like.

An example of the present invention was explained above with reference to the drawings. However, the example illustrated above exemplifies a backlight in a liquid crystal display in order to embody the technical concepts of the present invention. The present invention is not intended to be limited to this example, and may be equally applied to various modifications thereof which do not extend beyond the technical concepts as defined in the claims.

1. A backlight comprising a light guide plate, three or more linear lamps arranged along an end face of the light guide plate, an insulating spacer provided in an intermediate position in a longitudinal direction of said linear lamps for supporting said linear lamps, and a lamp reflector arranged so as to surround said linear lamps for reflecting light from the linear lamps to a light guide plate side,
said linear lamps being, when viewed from an end face side of the light guide plate, arranged so that all the linear lamps are directly visible without being shielded by another linear lamp, and among said linear lamps, a center linear lamp in a thickness direction of the light guide plate end face being arranged closer to the light guide plate side than other linear lamps,
said insulating spacer comprising a plurality of apertures, and among said plurality of apertures, a center aperture being arranged closer to the light guide plate side than other apertures, and
said lamp reflector comprising a back surface which faces the plurality of linear lamps and a side face for supporting the back surface against the light guide plate, said back surface having a convex portion projecting inward at a center portion along a longitudinal direction of the reflector.

2. The backlight according to claim 1, wherein said plurality of linear lamps is an uneven number.

3. The backlight according to claim 1, wherein a slit is formed along a longitudinal direction on said lamp reflector back surface, and cables connected to said linear lamps are housed in said slit.

4. The backlight according to claim 1, wherein at least one of the plural apertures of said insulating spacer is a through hole, and other apertures comprise a dividing slit which extends from a periphery to the aperture.

5. The backlight according to claim 4, wherein said insulating spacer is made from transparent silicon rubber.

6. The backlight according to claim 1, wherein said insulating spacer is provided with a taper whose contact surface area of at least one contact section with said linear lamps, lamp reflector, or light guide plate is made to decrease, and whose transverse cross-section shape is formed in a tapered manner.

7. The backlight according to claim 6, wherein the taper of said insulating spacer is formed from a plurality of planes.

8. The backlight according to claim 6, wherein said insulating spacer is formed from transparent silicon rubber.

9. A liquid crystal display which arranges the backlight according to any of claims 1 to 8 on a back surface of a liquid crystal panel.
